(19) United States
(12) Patent Application Publication
(10) Pub. No.: US 2014/0027071 A1
(43) Pub. Date: Jan. 30, 2014

(54) WINDOW BLIND INSERT

(71) Applicant: James Wesley Wilson, SR., Williamsburg, VA (US)

(72) Inventor: James Wesley Wilson, SR., Williamsburg, VA (US)

(21) Appl. No.: 13/562,283

(22) Filed: Jul. 30, 2012

(51) Int. Cl. E06B 9/38

(52) U.S. Cl. 160/173 R

(57) ABSTRACT

A window blind insert for a round or octagon-shaped window includes a frame that can fit inside the window. The frame holds a support bracket onto which slats can be attached. A handle bracket can be used to pivot the slats between a closed configuration and an opened configuration.

### BACKGROUND OF THE INVENTION

The present invention relates to window blinds and, more particularly, to a window blind insert for octagon or round windows.

Many homes and businesses have windows that are shaped in shapes other than the conventional rectangular shape. When a user wants to have a blind for a non-conventional window, such as a round or octagon-shaped window, they often need to resort to using a rectangular blind and lose the architectural and design highlight that such a window provides inside the home when the blinds are pulled.

As can be seen, there is a need for a window blind that can operate in a round or octagon-shaped window without losing the visibility of the window frame from inside the home.

### SUMMARY OF THE INVENTION

In one aspect of the present invention, a window blind insert comprises a frame adapted to fit inside a window frame; at least one support bracket extending from a top side of the frame to a bottom side of the frame; a plurality of slats pivotably attached to the at least one support bracket; and a handle bracket pivotably attached to the plurality of slats, wherein movement of the handle bracket pivots the plurality of slats between an open configuration and a closed configuration.

In another aspect of the present invention, a window blind insert comprises a frame adapted to fit inside a window frame; first and second support brackets extending from a top side of the frame to a bottom side of the frame; a plurality of support bracket clips extending from the first and second support brackets, the plurality of support bracket clips supporting the plurality of slats; a plurality of slats pivotably attached to the at least one support bracket; a handle bracket pivotably attached to the plurality of slats, wherein movement of the handle bracket pivots the plurality of slats between an open configuration and a closed configuration; and a plurality of handle bracket clips extending from the handle bracket, the handle bracket clips supporting the plurality of slats

These and other features, aspects and advantages of the present invention will become better understood with reference to the following drawings, description and claims.

### BRIEF DESCRIPTION OF THE DRAWINGS

FIG. 1 is a perspective view of a window blind insert disposed in an octagon-shaped window in a closed configuration according to an exemplary embodiment of the present invention;

FIG. 2 is a side view of the window blind insert of FIG. 1, in the closed configuration;

FIG. 3 is a perspective view of the window blind insert of FIG. 1 in a partially opened configuration;

FIG. 4 is a side view of the window blind insert of FIG. 3, in the partially opened configuration; and

FIG. 5 is an exploded perspective view of the window blind insert of FIG. 1.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a window blind insert for a round or octagon-shaped window. The window blind insert includes a frame that can fit inside the window. The frame holds a support bracket onto which slats can be attached. A handle bracket can be used to pivot the slats between a closed configuration and an opened configuration.

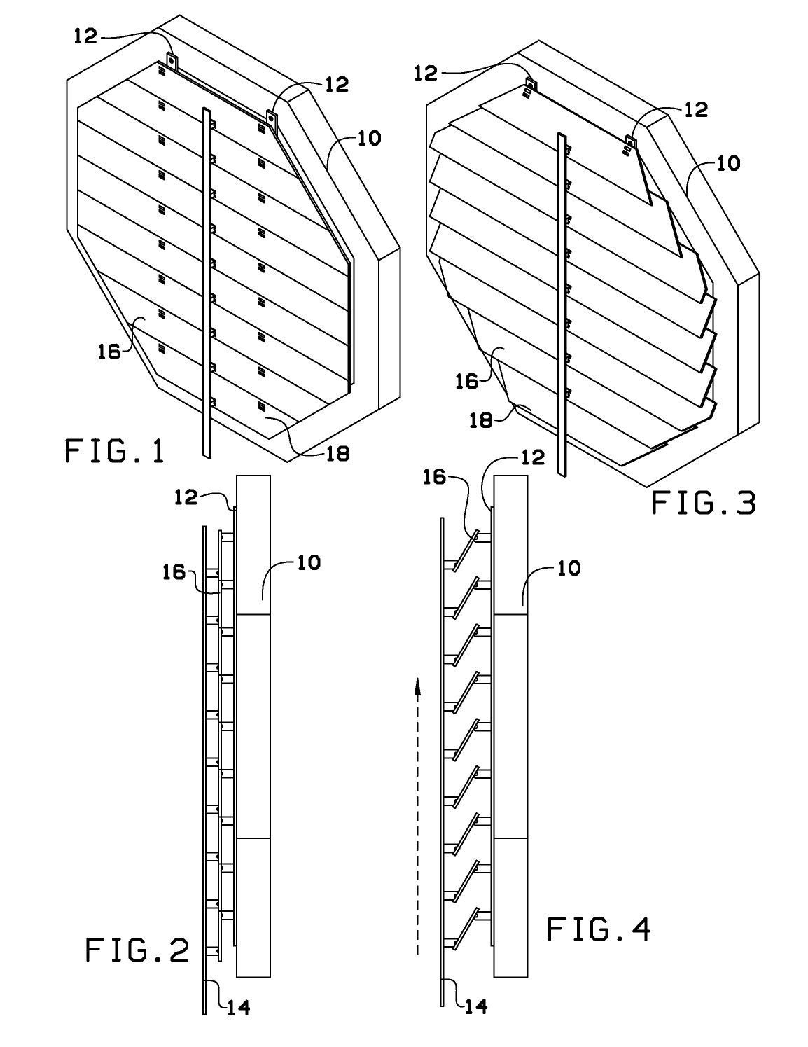

Referring now to FIGS. 1 through 5, a window blind insert can include a frame 10 that is sized to fit inside a window frame 24. The frame 10 can be shaped, for example, to fit into an octagon-shaped or round window, for example. The frame 10 can be made of various materials, such as wood, vinyl, plastic, or the like. In some embodiments, the frame can be made of recycled plastic. In some embodiments, each of the components of the window blind insert could be made from recycled plastic. The frame 10 can have a thickness from about 1/2 inch to about 2 inches, depending upon application and the structural need for the window blind insert.

At least one support bracket 12 may extend from a top end to a bottom end of the frame 10. Typically, two or more support brackets can be used in the window blind insert. The support brackets 12 may be formed integrally with the frame 10 or may be attached to the frame 10 by various methods, such as with fasteners 26.

Slats 16 may be pivotably mounted on the support brackets 12. The slats 16 may have slat slots 18 that support bracket clips 20, extending from the support brackets 12, can fit therein. A handle bracket 14 may attach to the slats 16. The slats 16 may have slat slots 18 that handle bracket clips 22, extending from the handle bracket 14, can fit therein.

The window blind insert of the present invention can be manufactured as a complete, assembled unit ready to simply insert into a window. Fasteners, such as screws, can be used to secure the window blind insert into the window. In other embodiments, the window blind insert can frictionally fit into the window or may be secured with a fastener such as a hook and loop fastener, such as Velcro®.

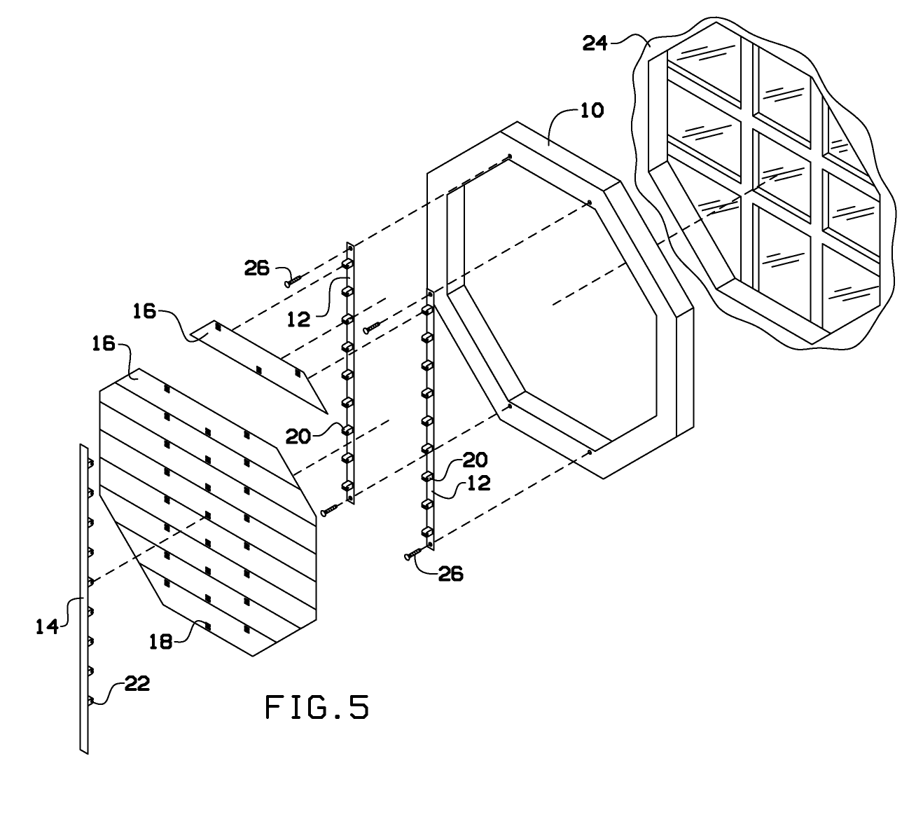

To use the window blind insert of the present invention, a user can simply move the handle bracket 14, as shown, for example, in FIG. 4, to more the slats between a closed configuration to an open configuration.

While the drawings show a window blind insert for an octagon-shaped window, the design of the present invention can be adapted to fit other window shapes and sizes. For example, the window blind insert of the present invention could be designed for round windows. Additionally, the window blind insert of the present invention could be designed for hexagonal-shaped windows, diamond-shaped windows, or the like.

It should be understood, of course, that the foregoing relates to exemplary embodiments of the invention and that modifications may be made without departing from the spirit and scope of the invention as set forth in the following claims.

1. A window blind insert comprising:
a frame adapted to fit inside a window frame;
at least one support bracket extending from a top side of the frame to a bottom side of the frame;
a plurality of slats continuously extending from one side of the frame to an opposite side of the frame, the plurality of slats pivotably attached to the at least one support bracket at a location disposed along a length of the plurality of slats; and
a handle bracket pivotably attached to the plurality of slats, wherein movement of the handle bracket pivots the plurality of slats between an open configuration and a closed configuration.

2. The window blind insert of claim 1, further comprising a plurality of support bracket clips extending from the at least one support bracket, the plurality of support bracket clips supporting the plurality of slats.

3. The window blind insert of claim 1, further comprising a plurality of handle bracket clips extending from the handle bracket, the handle bracket clips supporting the plurality of slats.

4. The window blind insert of claim 1, wherein the at least one support bracket includes a first support bracket and a second support bracket, the first and second support brackets running parallel to each other from the top side of the frame to the bottom side of the frame.

5. The window blind insert of claim 1, wherein the window frame is an octagon-shaped window frame.

6. (canceled)

7. A window blind insert comprising:
a frame adapted to fit inside a window frame;
first and second support brackets extending from a top side of the frame to a bottom side of the frame;
a plurality of support bracket clips extending from the first and second support brackets,;
a plurality of slats continuously extending from one side of the frame to an opposite side of the frame, the plurality of slats pivotably attached to the first and second support brackets and supported by the plurality of bracket clips at a location disposed along a length of the plurality of slats;
a handle bracket pivotably attached to the plurality of slats, wherein movement of the handle bracket pivots the plurality of slats between an open configuration and a closed configuration; and
a plurality of handle bracket clips extending from the handle bracket, the handle bracket clips supporting the plurality of slats, wherein
the plurality of slats extends to the edges of the frame without being attached, at ends of the plurality of slats, to the frame.

8. The window blind insert of claim 8, wherein the window frame is an octagon-shaped window frame.

9. (canceled)

10. A window blind insert comprising:
a frame adapted to fit inside a window frame;
first and second support brackets extending from a top side of the frame to a bottom side of the frame;
a plurality of support bracket clips extending from the first and second support brackets;
a plurality of slats continuously extending from one side of the frame to an opposite side of the frame, the plurality of slats pivotably attached to the first and second support brackets a location disposed along a length of the plurality of slats;
slat slots formed in the plurality of slats, the slat slots disposed along a length of the plurality of slats and disposed to receive the plurality of support bracket clips;
a handle bracket pivotably attached to the plurality of slats, wherein movement of the handle bracket pivots the plurality of slats between an open configuration and a closed configuration; and
a plurality of handle bracket clips extending from the handle bracket, the handle bracket clips supporting the plurality of slats, wherein
the plurality of slats extends to the edges of the frame without being attached, at ends of the plurality of slats, to the frame.
